(19) United States
(12) Patent Application Publication
(10) Pub. No.: US 2025/0078219 A1
(43) Pub. Date: Mar. 6, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: HIROYUKI HASEGAWA, Chiba (JP); SHINGO ISOBE, Kanagawa (JP)

(21) Appl. No.: 18/804,646

(22) Filed: Aug. 14, 2024

(30) Foreign Application Priority Data
Aug. 29, 2023 (JP) 2023-139123

(51) Int. Cl. G06T 5/73; G06T 7/00

(52) U.S. Cl. CPC G06T 5/73; G06T 7/0002; G06T 2207/30168

(57) ABSTRACT

There is provided with an image processing apparatus. An estimating unit estimates, from an image, an estimation value representing a transmittance of light in the atmosphere for each position in the image. A first determination unit determines, based on the estimation value, whether one of fog and haze has occurred in the image. A control unit switches, in a case where it is determined that one of the fog and haze has occurred, correction processing of the image from first correction processing to second correction processing.

### BACKGROUND OF THE INVENTION

### Field of the Invention

The present invention relates to an image processing apparatus, an image processing method, and a storage medium.

### Description of the Related Art

As one of crime prevention means, surveillance cameras have conventionally been used. Surveillance cameras are desired to be installed under various environments and to provide high visibility videos. However, if fog or haze occurs in a shooting environment of a surveillance camera, the contrast of an object lowers, resulting in a poor visibility image. To acquire a high visibility image even in a shooting environment in which fog or haze has occurred, there is provided a means for performing contrast enhancement in a case where fog or haze has occurred.

Fog or haze is not always constant, and changes in a state such as a concentration with time. Therefore, in a video, the lowering degree of the contrast due to fog or haze always changes. Thus, in a shooting environment in which a surveillance camera is installed, it is determined whether fog or haze has occurred, and contrast enhancement is performed only if fog or haze has occurred, thereby enabling correction according to the status. In a technique described in Japanese Patent No. 7000080, a histogram of luminance is detected, a ratio of a luminance distribution within a preset range from a determination point on the low luminance side to a determination point on the high luminance side to the overall histogram is calculated, and it is determined that fog or haze has occurred when the ratio exceeds a preset threshold.

### SUMMARY OF THE INVENTION

According to one embodiment of the present invention, an image processing apparatus comprises: at least one processor; and a memory coupled to the at least one processor, the memory storing instructions that, when executed by the at least one processor, cause the processor to act as: an estimating unit configured to estimate, from an image, an estimation value representing a transmittance of light in the atmosphere for each position in the image; a first determination unit configured to determine, based on the estimation value, whether one of fog and haze has occurred in the image; and a control unit configured to switch, in a case where it is determined that one of the fog and haze has occurred, correction processing of the image from first correction processing to second correction processing.

According to another embodiment of the present invention, an image processing method comprises: estimating, from an image, an estimation value representing a transmittance of light in the atmosphere for each position in the image; determining, based on the estimation value, whether one of fog and haze has occurred in the image; and switching, in a case where it is determined that one of the fog and haze has occurred, correction processing of the image from first correction processing to second correction processing.

According to yet another embodiment of the present invention, a non-transitory computer-readable storage medium stores a program which, when executed by a computer comprising a processor and a memory, causes the computer to: estimate from an image, an estimation value representing a transmittance of light in the atmosphere for each position in the image; determine, based on the estimation value, whether one of fog and haze has occurred in the image; and switch, in a case where it is determined that one of the fog and haze has occurred, correction processing of the image from first correction processing to second correction processing.

Further features of the present invention will become apparent from the following description of exemplary embodiments (with reference to the attached drawings).

### BRIEF DESCRIPTION OF THE DRAWINGS

FIG. 1 is a block diagram showing an example of the hardware arrangement of an image processing apparatus according to the first embodiment;

FIG. 2 is a flowchart illustrating an example of image processing executed by the image processing apparatus according to the first embodiment;

FIG. 3 is a graph showing an example of the histogram of the estimation value of the transmittance of light in the atmosphere; and

FIG. 4 is a flowchart illustrating an example of image processing executed by an image processing apparatus according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

If the presence/absence of fog or haze is determined only based on the luminance of an image, the presence of fog or haze may erroneously be determined in a color region where the luminance tends to be high.

Embodiments of the present invention provide an image processing apparatus for improving the determination accuracy of the presence/absence of fog or haze in an image.

### First Embodiment

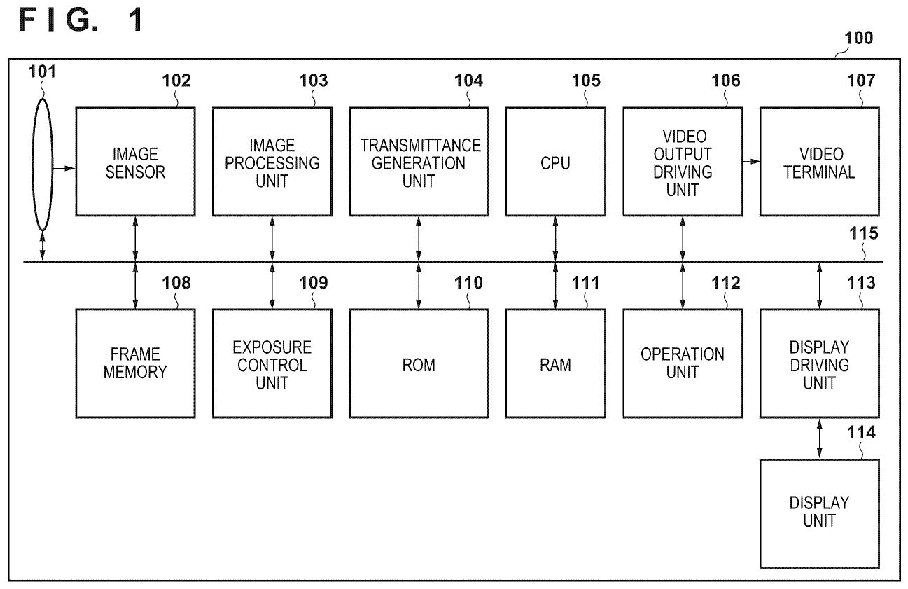

An image processing apparatus according to the first embodiment will be described with reference to FIG. 1. FIG. 1 is a block diagram showing an example of the hardware arrangement of an image processing apparatus 100.

In the example shown in FIG. 1, the image processing apparatus 100 includes an optical lens 101, an image sensor 102, an image processing unit 103, a transmittance generation unit 104, a CPU 105, a video output driving unit 106, a frame memory 108, an exposure control unit 109, a ROM 110, a RAM 111, an operation unit 112, and a display driving unit 113. The respective function units of the image processing apparatus 100 are connected, by an internal bus 115, to be able to transmit/receive data to/from each other. Assume that processing by the function units including the image processing unit 103 and the transmittance generation unit 104 according to this embodiment is controlled by the CPU 105.

The optical lens 101 is an optical element including a lens and a motor for driving the lens. The optical lens 101 operates based on a control signal, and can optically perform each process such as enlargement or reduction of a video or adjustment of a focal length. In addition, the optical lens 101 can adjust a light amount by controlling the opening area of a stop (for example, so as to obtain brightness corresponding to an operation amount by the user). The image sensor 102 forms an image of light transmitted through the lens.

The image sensor 102 is a CCD sensor, a CMOS sensor, or the like, and converts an optical signal into an electrical signal. The image sensor 102 is driven based on a control signal to reset charges in pixels or control a readout timing. The image sensor 102 can perform gain processing for a pixel signal read out as an analog electrical signal (voltage value) or convert an analog signal into a digital signal.

The image processing unit 103 performs various image processes for an image output from the image sensor 102. For example, the image processing unit 103 can correct a light amount on the periphery of an image generated by the characteristic of the optical lens 101, correct the sensitivity variation for each pixel of the image sensor 102, or perform image processing such as a correction concerning color or flicker correction. Furthermore, the image processing unit 103 performs sharpening processing using an estimation value estimated by the transmittance generation unit 104 and details thereof will be described later. Note that this embodiment assumes that values of an image to be processed are expressed in an RGB color space. However, the present invention is not particularly limited to this as long as the same processing can be performed.

If the transmittance generation unit 104 (to be described later) determines that fog or haze has occurred in an image, the image processing unit 103 according to this embodiment switches correction processing for the image from first correction processing to second correction processing. In this example, if it is determined that fog or haze has occurred, the image processing unit 103 can switch a state in which correction processing by a Dark Channel Prior (DCP) method (to be described later) is not performed to a state in which the correction processing by the DCP method is performed.

The transmittance generation unit 104 generates an estimation value representing the transmittance of light (ambient light) in the atmosphere using the DCP method to sharpen the image. The DCP method is a method of correcting the contrast using an image (dark channel image) obtained by extracting, for each pixel of interest, a smallest pixel value in all R, G, and B channels within a predetermined range around the pixel of interest. The image processing unit 103 can perform correction of removing fog or haze from the image by the DCP method. Therefore, it is possible to correct the image whose visibility lowers due to scattering and improve the contrast. Since the DCP method is a known technique, a detailed description of correction processing of the image by the DCP method will be omitted.

If a dark channel image is generated from an (clear) image in which fog or haze has not occurred, pixel values of the dark channel image are often close to 0 in most regions. On the other hand, with respect to a dark channel image generated from an image in which fog or haze has occurred, the pixel values of the dark channel image increase in accordance with the concentration of fog or haze, as compared with an image generated from a clear image, and thus a bright image is readily obtained. By using the dark channel image, it is possible to evaluate the concentration of fog or haze (that is, a distance to an object) in the image. Therefore, using the pixel values of the dark channel image, the transmittance generation unit 104 can estimate, as the estimation value of the transmittance of light in the atmosphere for each position in the image, a value obtained by evaluating the concentration of fog. The transmittance generation unit 104 according to this embodiment generates a transmittance map based on the dark channel image, and obtains a value in the transmittance map as the estimation value of the transmittance. The estimation value generation processing using the DCP method will be described later.

The exposure control unit 109 can control exposure based on an image value. For example, the exposure control unit 109 can detect the brightness of the image based on a signal detected from the image, and control the exposure stop, shutter speed, or gain so as to obtain predetermined brightness. The exposure control unit 109 can also control exposure based on a user input. In this case, the exposure control unit 109 may detect the brightness of the image based on a signal detected from the image, calculate a value representing the brightness in the current status with respect to proper brightness (desirably settable), and present it to the user.

The frame memory 108 is a memory generally called a Random Access Memory (RAM), and a video signal can temporarily be stored in the frame memory 108 and can be read out, as needed. Since the data amount of the video signal is often enormous, a high-speed and high-capacity memory is required as a memory for storing the video signal. As the frame memory 108, for example, a Dual Data Rate 4 Synchronous Dynamic RAM (DDR4-SDRAM) can be used. For example, the frame memory 108 is used to perform various image processes such as processing of compositing temporally different images or processing of cutting out only a necessary region in the image.

The CPU 105 is a Central Processing Unit (CPU) for controlling the respective function units of the image processing apparatus 100, and executes respective processes performed by the image processing apparatus 100. In the image processing apparatus 100, a Read Only Memory (ROM) and a RAM are connected to drive the CPU 105. The ROM 110 is a nonvolatile memory, and stores programs for operating the CPU 105, or pieces of information such as various adjustment parameters. A program read out from the ROM 110 is deployed in the nonvolatile RAM 111, and executed. As the RAM 111, for example, the frame memory 108 or a low-speed and low-capacity memory is used.

The image generated by the image processing unit 103 is output to an external apparatus of the image processing apparatus 100 via the video output driving unit 106 and a video terminal 107. As an interface for inputting/outputting data to/from the external apparatus, Serial Digital Interface (SDI), High Definition Multimedia Interface (HDMI®), DisplayPort®, or the like can be used. With this interface, it is possible to display a real-time video on an external monitor or the like.

Furthermore, the image generated by the image processing unit 103 is displayed on a display device via the display driving unit 113 and a display unit 114. The display unit 114 is a display device that can be visually perceived, and can display, for example, an image processed by the image processing unit 103, a setting menu, and the like to allow the user to confirm the operating status of the image processing apparatus 100. The display unit 114 can use, as the display device, a small device with low power consumption such as a Liquid Crystal Display (LCD) or an organic electroluminescence (EL) display. The display unit 114 may also include a resistive or capacitive thin-film element called a touch panel. The CPU 105 can generate display information such as a character string for notifying the user of the setting state of the image processing apparatus 100 and the like or a menu for setting of the image processing apparatus 100, and superimpose and display it on the image processed by the image processing unit 103 on the display unit 114. Display of the information on the display unit 114 may be shooting assist display such as histogram, vector scope, waveform monitor, zebra, peaking, or false color display.

The transmittance generation unit 104 calculates an estimation value (estimated transmittance) representing the transmittance in the atmosphere. Assume that the transmittance generation unit 104 generates a transmittance map indicating the estimated transmittance at each position in the image. The transmittance generation unit 104 according to this embodiment can generate an image (post-removal image) by correcting the processing target image to remove fog or haze based on the estimated transmittance. Each process performed by the transmittance generation unit 104 will be described below.

The transmittance generation unit 104 can generate a post-removal image from the processing target image by, for example, processing represented by equation (1) below. Equation (1) is an atmospheric model representing the correspondence between an image I before processing (before removing fog or haze) and a post-removal image J. Note that the size of the image before processing is equal to the size of the post-removal image.

$$I ( x , y ) = J ( x , y ) \times t ( x , y ) + A ( 1 - t ( x , y ) ) \qquad ( 1 )$$

where (x, y) represents a two-dimensional coordinate position (when, for example, an upper left end is set as an origin) in the horizontal direction and the vertical direction in the image, t(x, y) represents a value at (x, y) in the transmittance map of fog or haze, and A represents ambient light.

The transmittance map t(x, y) is a map representing a light reduction amount by the atmosphere for each position. The transmittance map t is generated so that a value (pixel value) in the transmittance map is larger as the distance to the object is longer and a value (pixel value) in the transmittance map is smaller as the distance to the object is shorter.

By estimating the ambient light A and the transmittance map t(x, y), it is possible to obtain J(x, y) after fog/haze removal by equation (1) above. A method of estimating the ambient light A will be described using a formula. The ambient light A is an average pixel value of RGB components in a sky region, and is calculated by:

$$A = {ave}_{d ∈ \{ r , g , b \}} ( {ave}_{( x , y ) ∈ Ω sky} {I}^{d} ( x , y ) ) \qquad ( 2 )$$

where the ave function is a function of calculating an average value in an argument, d represents a color component, and Ω sky represents a local region within the sky region. The sky region according to this embodiment is a region representing a space corresponding the sky in the image. A method of specifying a sky region in an image is not particularly limited. For example, an arbitrary known method of estimating a sky region such as a method of performing calculation based on the distribution of the histogram, a method using a coordinate position designated in advance, or a method using a position instructed by the user can be used. Similarly, a method of specifying a local region within the sky region to be used here is not particularly limited. Although the ambient light A is estimated using the image I(x, y) in which fog or haze has occurred in this example, the average value in the local region Ωsky may be calculated using dark channel values Idrk(x, y) (to be described later). Alternatively, instead of specifying the sky region, the average of the dark channel values Idrk(x, y) (to be described later) at predetermined positions (for example, positions at each of which the dark channel value is in upper 10%) may be set as the ambient light A.

Subsequently, the method of estimating the transmittance map t(x, y) will be described. The transmittance generation unit 104 according to this embodiment estimates the transmittance map t(x, y) based on the dark channel values. If, for example, an outdoor image in which fog or haze has not occurred and a pixel value of at least one component of RGB components is locally very small is used, it is possible to efficiently estimate the transmittance map. The dark channel value Idrk(x, y) is calculated by:

$$Idrk ( x , y ) = {min}_{d ∈ \{ r , g , b \}} {I}^{d} ( x , y ) \qquad ( 3 )$$

where d represents a color component and Ω represents a local region including the coordinates (x, y) of interest. The local region used here is the same as that used in equation (2). As given by equation (3), the dark channel value is the smallest value of the RGB components within the local region including the pixel of interest. By substituting dark channel calculation equation (3) into the atmospheric model of equation (1), expression (4) of calculating the dark channel value from the atmospheric model is obtained.

$$Idrk ⇋ Jdrk ( x , y ) \times t ( x , y ) + A ( 1 - t ( x , y ) ) \qquad ( 4 )$$

In an image in which fog or haze has not occurred, it is considered that the value of at least one of the RGB components is locally very small. A dark channel value Jdrk(x, y) in an image in which the pixel value of at least one component of the RGB components is locally small, such as an image in which fog or haze has not occurred, is a value very close to 0. Therefore, expression (4) can be approximated, given by:

$$Idrk ( x , y ) ⇋ A ( 1 - t ( x , y ) ) \qquad ( 5 )$$

The transmittance generation unit 104 can estimate the transmittance map t(x, y) using, for example, expression (6) obtained by deforming approximate expression (5).

$$t ( x , y ) ⇋ 1 - \{ ω \times \frac{Idrk ( x , y )}{A} \} \qquad ( 6 )$$

where ω represents a parameter for controlling the correction degree of fog or haze by the transmittance generation unit 104. As the value of ω is larger, the correction effect of removing fog or haze can be set more strongly. Assume here that ω is defined within the range of 0.0 to 1.0. The image processing unit 103 can obtain J(x, y) after fog/haze removal by substituting the ambient light A and the transmittance map t(x, y) calculated by expressions (2) to (6) into:

$$t ( x , y ) ⇋ 1 - \{ ω \times \frac{Idrk ( x , y )}{A} \} \qquad ( 7 )$$

Assume here that the estimated transmittance according to this embodiment indicates a transmittance map and includes no dark channel value.

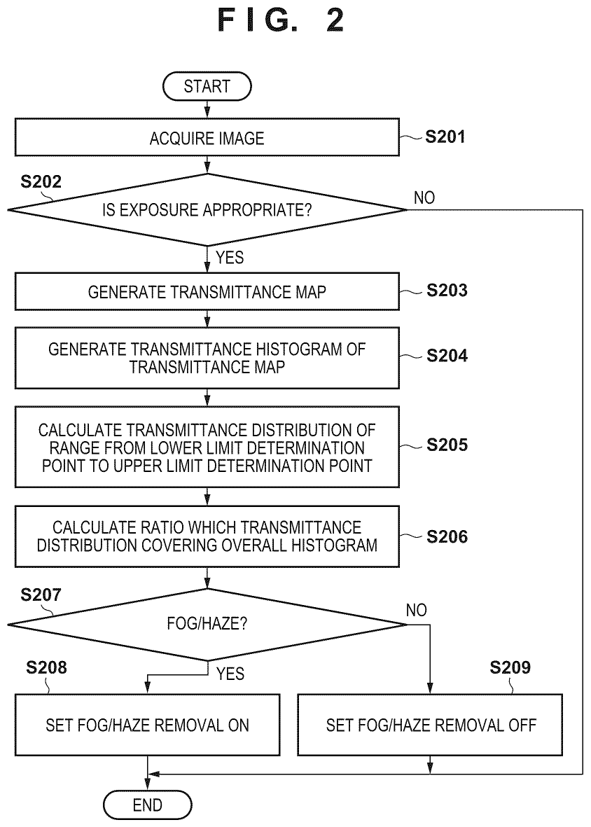

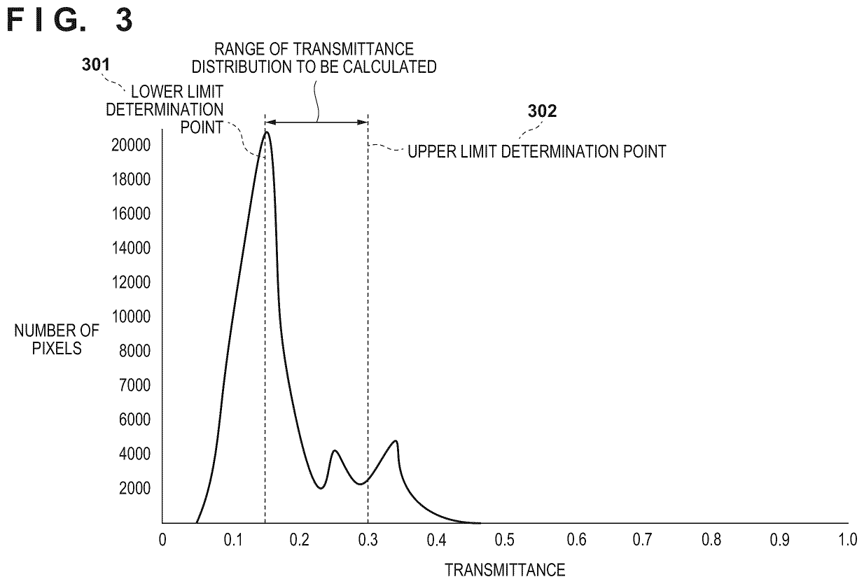

Processing, executed by the image processing apparatus 100, of correcting an image in a case where an estimation value representing the transmittance in the atmosphere in the image is estimated and it is determined based on the estimation value that fog or haze has occurred will be described next with reference to FIGS. 2 and 3. Processing shown in FIG. 2 may automatically be started after the image processing apparatus 100 is activated or may be started in response to a user operation. The processing shown in FIG. 2 may be started when setting of performing some or all of processes shown in FIG. 2 is made in advance. In this case, a menu for performing the setting is displayed on the display unit 114, thereby making it possible to accept a user input. In this embodiment, if setting of automatically performing the processing shown in FIG. 2 is made, the processing of FIG. 2 is assumed to be repeatedly executed.

In step S201, the CPU 105 acquires an image from the image sensor 102. Next, in step S202, based on the brightness of the image calculated by the exposure control unit 109, the CPU 105 determines whether exposure is appropriate. If it is determined that exposure is appropriate, the process advances to step S203. If it is determined that exposure is inappropriate, the processing ends. For example, since an image in a state in which charges in the pixels of the image sensor 102 are saturated is excessively exposed and it is difficult to correctly estimate the ambient light using the image, the reliability of the transmittance map is low. If exposure is manually controlled, it is considered that the exposure value is often inappropriate. It is determined whether exposure is appropriate. If it is determined that exposure is inappropriate, subsequent processing is terminated, thereby making it possible to determine, only in a state in which exposure is appropriate, whether fog or haze has occurred.

Note that the CPU 105 may determine, based on, for example, the brightness of the image, whether exposure is appropriate. For example, if the average value of the brightness of a predetermined region in the image falls outside a predetermined range (arbitrarily settable), it may be determined that exposure is inappropriate. As described above, whether exposure is appropriate can be determined arbitrarily using a known image processing technique. Whether exposure is appropriate may be determined in accordance with whether the setting of an image capturing apparatus falls within a predetermined setting range.

In step S203, the CPU 105 causes the transmittance generation unit 104 to generate, from the image acquired in step S201, a transmittance map using the DCP method. The transmittance generation unit 104 according to this embodiment generates a transmittance map including, as an element, an estimation value representing the transmittance of light in the atmosphere for each position in the image. If the ratio of the estimation values falling within a predetermined range to all the estimation values is equal to or higher than a threshold, the transmittance generation unit 104 can determine that fog or haze has occurred in the processing target image. In this example, by illustrating the elements of the transmittance map by a histogram shown in FIG. 3 (to be described later), the transmittance generation unit 104 determines whether the ratio of the elements between a lower limit determination point 301 and an upper limit determination point 302 to all the elements is equal to or higher than a threshold. The histogram showing the elements of the transmittance map will simply be referred to as “the histogram of the transmittance map” hereinafter.

FIG. 3 is a graph showing an example of the range of the lower limit determination point to the upper limit determination point of the transmittance in the histogram according to the first embodiment. If, for example, the lower limit determination point 301 is set to a transmittance of 0.15 and the upper limit determination point 302 is set to a transmittance of 0.3, the transmittance distribution within the transmittance range is calculated, as shown in FIG. 3. The lower limit determination point 301 and the upper limit determination point 302 are preset values, and can experimentally or empirically be set as design values in accordance with, for example, the application purpose, performance, or shooting environment of a camera. Furthermore, the lower limit determination point 301 and the upper limit determination point 302 may be settable or changeable by a user operation via the operation unit 112. By changing the set values of the lower limit determination point 301 and the upper limit determination point 302, a criterion for determining the concentration of fog or haze that has occurred can be changed.

In step S204, the transmittance generation unit 104 generates the histogram of the transmittance map. In step S205, the transmittance generation unit 104 calculates the transmittance distribution within the range of the lower limit determination point to the upper limit determination point in the histogram.

In step S206, the transmittance generation unit 104 calculates the ratio of the transmittance distribution, calculated in step S205, within the range of the lower limit determination point 301 to the upper limit determination point 302 to the transmittance histogram of the overall image. In step S207, the CPU 105 determines whether the ratio calculated in step S206 is equal to or higher than a preset threshold. If the ratio is equal to or higher than the threshold, the process advances to step S208. If the ratio is lower than the threshold, the process advances to step S209. For example, if the threshold is set to 50%, when 50% or more of the transmittance distribution falls within the above-described range, the transmittance generation unit 104 determines that fog or haze has occurred. This threshold may be settable or changeable by, for example, a user operation via the operation unit 112.

If the range of the lower limit determination point 301 to the upper limit determination point 302 is widened or the threshold of the ratio of the transmittance distribution within the range to the overall transmittance histogram is decreased, the transmittance generation unit 104 readily determines, from the histogram of the image, that fog or haze has occurred. If the range of the lower limit determination point 301 to the upper limit determination point 302 is narrowed or the threshold of the ratio of the transmittance distribution within the range to the overall transmittance histogram is increased, the transmittance generation unit 104 hardly determines, from the histogram of the image, that fog or haze has occurred. In this way, by changing the determination points or the setting of the threshold (by the user, for example), it is possible to change the determination criterion in accordance with a desired condition. If the user sets the threshold, it may be possible to set the values of the lower limit determination point 301 and the upper limit determination point 302 via a menu screen by, for example, operating the operation unit 112.

Note that in this example, the transmittance is evaluated based on the ratio of the elements within the predetermined range using the histogram. The present invention is not particularly limited to this as long as the transmittance in the image can be evaluated. For example, if the average value of the elements in the transmittance map is calculated and is equal to or larger than a predetermined threshold, it may be determined that fog or haze has occurred in the image.

In step S208, by using the ambient light estimation value and the transmittance map generated by the transmittance generation unit 104, the image processing unit 103 corrects the image acquired from the image sensor 102, and generates a post-removal image by removing fog or haze, thereby ending the processing. In step S209, the image processing unit 103 outputs the image acquired from the image sensor 102 without performing such image correction.

In a case where the ambient light is estimated directly using the dark channel value Idrk(x, y), if exposure is changed (especially if the user manually changes exposure), a calculated value also changes, thereby influencing the result of determining whether fog or haze has occurred. On the other hand, the value t(x, y) in the transmittance map according to this embodiment is a value normalized using the ambient light A, as indicated by expression (6). Therefore, by determining, using the transmittance map, whether fog or haze has occurred, it is possible to perform determination that is hardly influenced by a change in brightness of the whole screen caused by an exposure change. Thus, even if the user manually changes exposure, by performing the determination using the transmittance map, it is possible to appropriately determine whether fog or haze has occurred, without changing the lower limit determination point 301 or the upper limit determination point 302.

With this processing, if the estimation value representing the transmittance of light in the atmosphere in the image is estimated and it is determined, based on the estimation value, that fog or haze has occurred in the image, it is possible to correct the image. Therefore, regardless of the luminance and saturation values (for example, even though the luminance and saturation are high), it is possible to correctly determine whether fog or haze has occurred in the image. Especially, by performing the determination based on the transmittance map generated from the dark channel values, it is possible to perform the determination more correctly.

Note that in this embodiment, control of performing, as the second correction processing, the correction processing of the image using the DCP method and not performing the correction processing as the first correction processing is executed. However, the present invention is not limited to this switching processing as long as the correction processing can be switched in accordance with a result of determining whether fog or haze has occurred. For example, the correction processing of the image may be controlled so as to perform, as the first correction processing, level correction corresponding to the brightness of the image and to switch, if it is determined that fog or haze has occurred, to the correction processing using the DCP method.

### Second Embodiment

The second embodiment of the present invention will be described below. In the first embodiment, the average pixel value of the RGB components is used as the ambient light A and the smallest value of the RGB components is used to calculate the dark channel value and the transmittance map. However, in this embodiment, these calculation operations are performed for each of RGB color components. That is, an R image, a G image, and a B image obtained by extracting an image for each component are prepared, and the same processing as in the first embodiment is performed for each image. Processes executed by a transmittance generation unit 104 and an image processing unit 103 according to this embodiment will be described below.

In this embodiment, ambient light A(c) for each color component is calculated by:

$$A ( c ) = {ave}_{( x , y , c ) ∈ Ω sky} I ( x , y , c ) \qquad ( 8 )$$

The ave function is a function of calculating an average value in an argument. Furthermore, c represents a color component. Processing is performed for the R image when c=1, processing is performed for the G image when c=2, and processing is performed for the B image when c=3. Ωsky represents a local region within a sky region. Similar to the first embodiment, a method of specifying the sky region and the local region is not particularly limited. Although, in this example, the ambient light A(c) is estimated using the image I(x, y, c) in which fog or haze has occurred, the average value in the local region Ωsky may be calculated using dark channel values Idrk(x, y, c) (to be described later). Alternatively, instead of specifying the sky region, the average of the dark channel values Idrk(x, y, c) (to be described later) at predetermined positions (for example, positions at each of which the dark channel value is in upper 10%) may be set as the ambient light A(c).

The dark channel value Idrk(x, y, c) for each color component is calculated by:

$$Idrk ( x , y , c ) = {min}_{( x , y , c ) ∈ Ω} I ( x , y , c ) \qquad ( 9 )$$

where c represents a color component. Processing is performed for the R image when c=1, processing is performed for the G image when c=2, and processing is performed for the B image when c=3. Ω represents a local region including the coordinates (x, y, c) of interest. The local region used here is the same as that used in equation (8). As given by equation (9), the dark channel value is the smallest value in the local region including the pixel of interest. By substituting dark channel calculation equation (9) into the atmospheric model of equation (1), equation (10) of calculating the dark channel value for each of the RGB color components from the atmospheric model is obtained.

$$Idrk ( c ) = Jdrk ( x , y , c ) \times t ( x , y , c ) + A ( 1 - t ( x , y , c ) ) \qquad ( 10 )$$

In an image in which fog or haze has not occurred, it is considered that the value of at least one of the RGB components is locally very small. A dark channel value Jdrk(x, y, c) in an image in which the pixel value of at least one component of the RGB components is locally small, such as an image in which fog or haze has not occurred, is a value very close to 0. Therefore, equation (10) can be approximated, given by:

$$Idrk ( x , y , c ) ⇋ A ( 1 - t ( x , y , c ) ) \qquad ( 11 )$$

The transmittance generation unit 104 can estimate the transmittance map t(x, y, c) for each of the RGB color components using expression (12) obtained by deforming approximate expression (11).

$$t ( x , y , c ) ⇋ 1 - \{ ω \times \frac{Idrk ( x , y , c )}{A ( c )} \} \qquad ( 12 )$$

where ω represents a parameter for controlling the correction degree of fog or haze by the transmittance generation unit 104. As the value of ω is larger, the correction effect of fog or haze can be set more strongly. Assume here that ω is defined within the range of 0.0 to 1.0. The image processing unit 103 can obtain J(x, y, c) after fog/haze removal by substituting the ambient light A(c) and the transmittance map t(x, y, c) calculated by expressions (8) to (12) into:

$$J ( x , y , c ) = \{ \frac{I ( x , y , c ) - A ( c )}{t ( x , y , c )} \} + A ( c ) \qquad ( 13 )$$

By calculating J(x, y, c) for each color component using equation (13), it is possible to generate an image (to be referred to as a non-scattered image hereinafter) by removing a component (to be referred to as a Mie scattering component hereinafter) corresponding to Mie scattering and a component (to be referred to as a Rayleigh scattering component hereinafter) corresponding to Rayleigh scattering.

By using equation (13) using the smallest value of the ambient light estimation value A(c) and the transmittance map t(x, y, c) calculated for each color component, it is possible to generate an image (to be referred to as a Mie scattering-removed image hereinafter) by removing the Mie scattering component. Furthermore, it is possible to extract the Mie scattering component by subtracting the Mie scattering-removed image from an original image acquired from an image sensor 102. It is possible to extract the Rayleigh scattering component by subtracting the non-scattered image and the Mie scattering component from the original image acquired from the image sensor 102. It is possible to calculate the relative value between the Mie scattering component and the Rayleigh scattering component by dividing the extracted Mie scattering component and Rayleigh scattering component by the original image acquired from the image sensor 102.

Assume here that the estimated transmittance according to this embodiment indicates the relative Mie scattering component or Rayleigh scattering component and includes no dark channel value.

As described above, the transmittance generation unit 104 according to this embodiment estimates the evaluation value of the scattering component including the Mie scattering component or Rayleigh scattering component based on the transmittance map, and determines, using the scattering component, whether fog or haze has occurred. At this time, the transmittance generation unit 104 can perform the determination using the scattering component instead of the elements of the transmittance map in the first embodiment, and a repetitive description will be omitted.

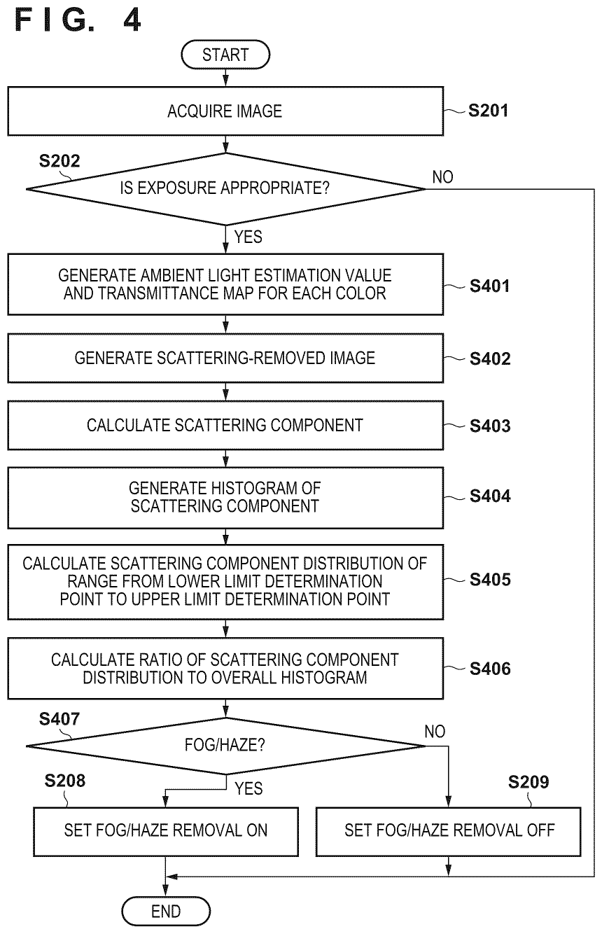

Processing, executed by an image processing apparatus 100 according to this embodiment, of correcting an image in a case where it is determined that fog or haze has occurred will be described next with reference to FIG. 4. FIG. 4 is a flowchart illustrating the processing executed by the image processing apparatus 100 according to this embodiment. The processing shown in FIG. 4 is performed as in FIG. 2 except that steps S401 to S409 are executed instead of steps S203 to S207 and a repetitive description will be omitted.

In step S401, a CPU 105 causes the transmittance generation unit 104 to generate, from the image acquired in step S201, an ambient light estimation value and a transmittance map for each color component using the DCP method. In step S402, the CPU 105 causes the image processing unit 103 to generate a non-scattered image and a Mie scattering-removed image using the image acquired in step S201, and the ambient light estimation value and the transmittance map generated for each color component in step S401.

In step S403, the CPU 105 causes the transmittance generation unit 104 to calculate relative values of the Mie scattering component and the Rayleigh scattering component with respect to the pixel values using the image acquired in step S201, and the non-scattered image and the Mie scattering-removed image generated in step S402. Note that instead of the relative values of the Mie scattering component and the Rayleigh scattering component with respect to the pixel values, a relative value of a scattering component, obtained by combining Mie scattering and Rayleigh scattering, with respect to the pixel value may be calculated.

In step S404, the CPU 105 causes the transmittance generation unit 104 to generate a histogram of the scattering component calculated in step S403. Note that in this example, a histogram is generated with respect to the scattering component in step S404. However, a histogram of a Mie scattering component or and a Rayleigh scattering component may be used.

In step S405, the transmittance generation unit 104 calculates the scattering component distribution within the range of a lower limit determination point to an upper limit determination point in the histogram. Since the histogram is generated in the same manner as in FIG. 3 described in the first embodiment, a repetitive description will be omitted.

In step S406, the transmittance generation unit 104 calculates the ratio of the scattering component distribution, calculated in step S405, within the range of the lower limit determination point to the upper limit determination point to the scattering component histogram of the overall image. In step S407, the CPU 105 determines whether the ratio calculated in step S406 is equal to or higher than a preset threshold. If the ratio is equal to or higher than the threshold, the process advances to step S208. If the ratio is lower than the threshold, the process advances to step S209. For example, if the threshold is set to 50%, when 50% or more of the scattering component distribution falls within the above-described range, the transmittance generation unit 104 determines that fog or haze has occurred. This threshold may be settable or changeable by, for example, a user operation via an operation unit 112.

If the range of a lower limit determination point 301 to an upper limit determination point 302 is widened or the threshold of the ratio of the scattering component distribution within the range to the overall scattering component histogram is decreased, the transmittance generation unit 104 readily determines, from the histogram of the image, that fog or haze has occurred. If the range of the lower limit determination point to the upper limit determination point is narrowed or the threshold of the ratio of the scattering component distribution within the range to the overall scattering component histogram is increased, the transmittance generation unit 104 hardly determines, from the histogram of the image, that fog or haze has occurred. In this way, by changing the determination points or the setting of the threshold (by the user, for example), it is possible to change the determination criterion in accordance with a desired condition. If the user sets the threshold, it may be possible to set the values of the lower limit determination point 301 and the upper limit determination point 302 via a menu screen by, for example, operating the operation unit 112.

Note that the relative value of the scattering component is evaluated using the histogram in this example. The present invention is not limited to this as long as the relative value of the scattering component in the image can be evaluated. For example, if the average value of the scattering components is calculated and is equal to or larger than a predetermined threshold, it may be determined that fog or haze has occurred in the image.

In step S208, by using the ambient light estimation value and the transmittance map generated by the transmittance generation unit 104, the image processing unit 103 corrects the image acquired from the image sensor 102, and generates a post-removal image by removing fog or haze, thereby ending the processing. In step S209, the image processing unit 103 outputs the image acquired from the image sensor 102 without performing such image correction.

With this processing, if the estimation value representing the transmittance of light in the atmosphere in the image is estimated and it is determined, based on the estimation value, that fog or haze has occurred in the image, it is possible to correct the image. Therefore, regardless of the luminance and saturation values (for example, even though the luminance and saturation are high), it is possible to correctly determine whether fog or haze has occurred in the image. Especially, by performing the determination based on the transmittance map generated from the dark channel values, it is possible to perform the determination more correctly.

Since the dark channel value is an absolute value, if exposure is changed, the value also changes. Therefore, since, if exposure is changed, the calculated dark channel value also changes, when estimating ambient light directly using the dark channel value, a result of determining whether fog or haze has occurred is influenced. On the other hand, by estimating ambient light using the relative value of the scattering component, it is possible to perform determination that is hardly influenced by a change in brightness of the whole screen caused by an exposure change. Thus, even if the user manually changes exposure, by performing the determination using the relative value of the scattering component, it is possible to appropriately determine whether fog or haze has occurred, without changing the lower limit determination point 301 or the upper limit determination point 302.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139123, filed Aug. 29, 2023, which is hereby incorporated by reference herein in its entirety.

What is claimed is:

1. An image processing apparatus comprising:
at least one processor; and
a memory coupled to the at least one processor, the memory storing instructions that, when executed by the at least one processor, cause the processor to act as:
an estimating unit configured to estimate, from an image, an estimation value representing a transmittance of light in the atmosphere for each position in the image;
a first determination unit configured to determine, based on the estimation value, whether one of fog and haze has occurred in the image; and
a control unit configured to switch, in a case where it is determined that one of the fog and haze has occurred, correction processing of the image from first correction processing to second correction processing.

2. The apparatus according to claim 1, wherein in a case where a ratio of positions at each of which the estimation value falls within a predetermined range is not lower than a first threshold in the image, the first determination unit determines that one of the fog and haze has occurred in the image.

3. The apparatus according to claim 1, wherein in a case where an average value of the estimation values in the image is not lower than a second threshold, the first determination unit determines that one of the fog and haze has occurred in the image.

4. The apparatus according to claim 1, wherein the estimating unit estimates, as the estimation value, a value obtained by evaluating a concentration of the fog in the atmosphere.

5. The apparatus according to claim 1, wherein the estimating unit estimates an evaluation value of a scattering component of light as the estimation value.

6. The apparatus according to claim 1, wherein a scattering component of the light includes one of a Mie scattering component and a Rayleigh scattering component.

7. The apparatus according to claim 1, further comprising a second determination unit configured to determine, based on the image, whether exposure in the image is appropriate,
wherein in a case where it is determined that the exposure is appropriate, the estimating unit estimates the estimation value.

8. An image processing method comprising:
estimating, from an image, an estimation value representing a transmittance of light in the atmosphere for each position in the image;
determining, based on the estimation value, whether one of fog and haze has occurred in the image; and
switching, in a case where it is determined that one of the fog and haze has occurred, correction processing of the image from first correction processing to second correction processing.

9. The apparatus according to claim 8, wherein in a case where a ratio of positions at each of which the estimation value falls within a predetermined range is not lower than a first threshold in the image, it is determined that one of the fog and haze has occurred in the image.

10. The apparatus according to claim 8, wherein in a case where an average value of the estimation values in the image is not lower than a second threshold, it is determined that one of the fog and haze has occurred in the image.

11. The apparatus according to claim 8, wherein a value obtained by evaluating a concentration of the fog in the atmosphere is estimated as the estimation value.

12. The apparatus according to claim 8, wherein an evaluation value of a scattering component of light as the estimation value is estimated.

13. The apparatus according to claim 8, wherein a scattering component of the light includes one of a Mie scattering component and a Rayleigh scattering component.

14. The apparatus according to claim 8, further comprising determining, based on the image, whether exposure in the image is appropriate,
wherein in a case where it is determined that the exposure is appropriate, the estimating unit estimates the estimation value.

15. A non-transitory computer-readable storage medium storing a program which, when executed by a computer comprising a processor and a memory, causes the computer to:
estimate from an image, an estimation value representing a transmittance of light in the atmosphere for each position in the image;
determine, based on the estimation value, whether one of fog and haze has occurred in the image; and
switch, in a case where it is determined that one of the fog and haze has occurred, correction processing of the image from first correction processing to second correction processing.
